(19) United States
(12) Patent Application Publication
(10) Pub. No.: US 2024/0240028 A1
(43) Pub. Date: Jul. 18, 2024

(54) METHOD FOR THE PRODUCTION OF A HYDROPHILIC COATING OF A FLUOROPOLYMER MATERIAL

(71) Applicants: Hueck Folien Gesellschaft m.b.H., Baumgartenberg (AT); Nowofol Kunststoffprodukte GmbH & Co. KG, Siegsdorf (DE)

(72) Inventors: Alexander HOELLMUELLER, Ennsdorf (AT); Olivier LORRET, Ennsdorf (AT); Thomas LINDMEIR, Wartberg ob der Aist (AT); Andreas FREUTSMIEDL, Uebersee (DE); Ulrich VON GROSSMANN, Siegsdorf (DE); Alexander BEHAMER, Soechtenau (DE)

(73) Assignees: Hueck Folien Gesellschaft m.b.H., Baumgartenberg (AT); Nowofol Kunststoffprodukte GmbH & Co. KG, Siegsdorf (DE)

(21) Appl. No.: 18/561,847

(22) PCT Filed: May 12, 2022
(86) PCT No.: PCT/EP2022/062935

§ 371 Date: Nov. 17, 2023

(30) Foreign Application Priority Data
May 20, 2021 (EP) 21175077.3

(51) Int. Cl. C09D 1/04; B05C 1/08; C08J 7/056; C09D 5/00; C09D 5/02; C09D 7/40

(52) U.S. Cl. CPC C09D 1/04; B05C 1/08; C08J 7/056; C09D 5/002; C09D 5/027; C09D 7/67; C08J 2327/12

(57) ABSTRACT

A method for the production of a hydrophilic coating of a fluoropolymer material, preferably of a fluoropolymer film, includes the steps of: providing an aqueous dispersion of silicate nanoparticles, applying the silicate dispersion to the fluoropolymer material, and drying the applied coating, wherein a coated fluoropolymer material is obtained which has a contact angle with water of less than 30°. The fluoropolymer material thus coated is extremely weather-resistant and exhibits a long service life.

### FIELD OF THE INVENTION

The invention relates to a method for the production of a hydrophilic coating of a fluoropolymer material, wherein a coated fluoropolymer material is obtained which has a contact angle with water of less than 30°, as well as to a hydrophilic fluoropolymer material which can be obtained by said method.

### PRIOR ART

Fluoropolymers, or fluoroplastics, are polymers based on fluorocarbons having multiple carbon-fluorine bonds in which usually a large proportion or even all of the hydrogens otherwise present are replaced by fluorine. The best known fluoropolymers include, inter alia, polyvinyl fluoride (PVF), polyvinylidene difluoride (PVDF), polytetrafluoroethylene (PTFE), ethylene tetrafluoroethylene (ETFE), perfluoroalkoxy polymers (PFA) and tetrafluoroethylene-hexafluoropropylene copolymers (FEP).

Fluoropolymers have high a chemical and thermal stability, good electrical insulation properties, excellent weather resistance, a good notch impact strength, anti-adhesive behaviour, and they are incombustible. A consequence of the anti-adhesive behaviour is a low wettability as well as low-friction properties. In addition, fluoropolymers are physiologically innocuous.

These properties make fluoropolymers highly versatile. Thus, for example, they are used in high performance bearings and seals for automobiles and aircraft, fire-resistant materials, cable coatings, coatings for kitchen products, pipes and chemical tanks as well as implants and catheters for biomedical applications.

Ethylene-tetrafluoroethylene copolymer (ETFE) is a fluorocopolymer which consists of the monomers tetrafluoroethylene and ethylene and, for example, is known under the trade names Dyneon ETFE (Dyneon), Tefzel (DuPont), Fluon ETFE (Asahi Glass) as well as F-Clear for films. ETFE is a derivative of the plastic PTFE, also known as Teflon.

Films produced from ETFE have a low dead weight as well as a high light and UV transmittance (at 200 nm, for a 25 μm thick film, it is 91.5%, while window glass is opaque at this wavelength). For this reason, ETFE films with a thickness of 50 to 250 μm are frequently used in architecture in membrane constructions, wherein the films are used, for example, for roofing pools and greenhouses or other buildings such as football stadia.

However, because of the low water wettability of such films due to their hydrophobic nature, an unwanted water condensation formation may which can lead to a occur, deterioration in the light transmittance, and the drips falling from it, in particular in greenhouses, may have a negative impact on the growth of the cultivated plants.

In order to avoid these problems, hydrophilically coated polyethylene films (for example employing the method of EP 1 647 568 A1) are often used when designing greenhouses and polytunnels. They are UV-permeable and also chemically resistant, and because of their hydrophilic characteristics they develop an anti-dewing and anti-fogging action. However, the service life of such PE films is rather short at only a few years, which is why these films usually have to be changed every 2-3 years.

It is therefore desirable and advantageous to make ETFE films, which have a very long service life, more hydrophilic, i.e. to reduce the water contact angle, in particular to less than 30°.

In accordance with EP 1 319 495 A1, an ETFE film is provided with a hydrophilic property by coating with a colloidal sol produced from inorganic material such as SiO₂ or by sputtering with an oxide of a metal such as Si and/or Sn.

In EP 2 096 191 A1, a method is described in which a fluorine-doped silicon oxide layer is applied to an ETFE substrate by means of plasma CVD. This layer provides the substrate with a high light transmittance and a water contact angle of at most 20°.

### Objective of the Invention

The objective of the invention is to overcome the disadvantages of the prior art and to provide a hydrophilic fluoropolymer material which has a contact angle with water of less than 30° and a long service life, as well as to propose a technically relatively simple method for the production of a hydrophilic coating by means of which such a weather-resistant fluoropolymer material can be obtained.

### DISCLOSURE OF THE INVENTION

This objective is achieved by means of a method of the aforementioned type with the features of the independent claims. Further embodiments of the invention form the subject matter of the dependent claims.

In accordance with the first aspect of the invention, a method for the production of a hydrophilic coating of a fluoropolymer material, preferably of a fluoropolymer film, wherein a coated fluoropolymer material is obtained which has a contact angle with water of less than 30°, comprises the following steps:
providing an aqueous dispersion of silicate nanoparticles,
applying the silicate dispersion onto the fluoropolymer material, and
drying the applied coating.

In contrast to the prior art, in accordance with the invention, it is not necessary to make use of plasma-based chemical gas phase (or vapour) deposition or similar processes, which necessitate the use of complicated and expensive equipment and installations, in order to apply the coating. In accordance with the invention, the coating is carried out by conventional coating procedures such as painting or dip coating which, for example, can be carried out using conventional installations for printing and painting.

During the thermal drying carried out in accordance with the invention after the application of the nanoparticle dispersion to the fluoropolymer material, the nanoparticles can orientate and organise themselves in a manner such that the desired hydrophilic effect is produced. The nanoscale structures which are formed, for the production of which a certain particle size distribution of the silicate particles in the dispersion is advantageous, result in that the contact angle of the coated fluoropolymer films with water is less than 30°, and therefore a disadvantageous formation of condensation, in particular when using the films for greenhouses, is prevented.

According to a preferred embodiment, the mean value of the particle size distribution in the dispersion is 1-100 nm, preferably 5-80 nm, particularly preferably 10-60 nm.

In accordance with another preferred embodiment, drying of the applied coating is carried out at a temperature of 40-130° C., preferably 60-120° C., particularly preferably 60-100° C.

According to a further embodiment of the method in accordance with the invention, the drying of the applied coating is preferably carried out for a period of 0.01-8 min, preferably 0.05-7 min, particularly preferably 0.1-5 min.

In a preferred embodiment, the silicate nanoparticles comprise tetraalkoxysilanes such as tetraethyl orthosilicate (TEOS; also known as ethyl silicate or tetraethoxysilane), tetramethyl orthosilicate (TMOS), tetrapropyl orthosilicate (TPOS) and their polymers; preferably, the silicate nanoparticles consist thereof.

Preferably, the fluoropolymer material which is coated is ethylene-tetrafluoroethylene copolymer (ETFE), polyvinylidene difluoride (PVDF) and/or a fluoropolymer (FP).

The fluoropolymer material which is provided with the hydrophilic coating, i.e. the fluoropolymer film, for example, may already have been coated before the method in accordance with the invention is put into practice. As an example, layers of bonding agents or primers may be formed on the fluoropolymer material, on top of which the silicate dispersion is applied.

In accordance with one embodiment, the surface energy of the fluoropolymer material is advantageously raised by means of priming, wherein the priming is preferably carried out on the basis of water-dilutable acrylate and/or polyurethane binders.

Because fluoropolymers are inert to reactions, chemical bonding is normally difficult, which is why, for good adhesion of the coating to the film, it may be advantageous for the surface energy of the fluoropolymer material to be increased before coating, by means of priming. This can improve the chemical and physical properties of the silicate coating and therefore its adhesion. Preferred primers in this regard are binders based on acrylates or polyurethanes.

As an example, the silicate dispersion is applied to the fluoropolymer material with a layer thickness of 0.1-30 μm.

The dry quantity of the layer applied to the fluoropolymer material may be 0.1-20 g/m², for example.

The application of the silicate dispersion the fluoropolymer material is preferably carried out at atmospheric pressure. This means that, advantageously, simple printing equipment and coating lines can be used to process the dispersion.

Preferably, drying of the applied coating is carried out by means of a recirculating air dryer. This enables homogeneous drying which furthermore occurs more quickly.

In accordance with a preferred embodiment, the application of the silicate dispersion onto a fluoropolymer film is carried out by means of a gravure cylinder in a coating line, wherein the dryer length is preferably 10-50 m and the web speed is 10-100 m/min.

The invention will be explained in more detail below with the aid of an example.

The second aspect of the invention concerns a hydrophilic fluoropolymer material which has a contact angle with water of less than 30° and in particular can be obtained by means of the method for the production of a hydrophilic coating described above.

Preferably, this hydrophilic fluoropolymer material is a coated fluoropolymer film.

### EXAMPLE

The example shows that the coating of silicate nanoparticles produced in accordance with the invention leads to the surface of the fluoropolymer material becoming hydrophilic, whereupon a film of water can form on the surface.

For preparing the aqueous dispersion, tetraethyl silicate nanoparticles, which may optionally have been hydrophilically surface-modified, are dispersed in water. The solids content of the dispersion is approximately 10% by weight.

Processing and applying the water-dilutable silicate dispersion to a film of ETFE is carried out using a gravure cylinder at a coating line which is operated at atmospheric pressure. The gravure cylinder here dips into a pan which is filled with the dispersion. After doctoring the cylinder, the coating medium is transferred onto the film which is being fed over guide rolls and pressed onto the gravure cylinder.

Next, the applied is through a coating guided recirculating air dryer. The web or drying length here is 10-50 m and the web speed is set at 10-100 m/min. During the drying procedure, the reaction temperature reaches a value of between 60° C. and 100° C. The dry quantity of the layer applied to the ETFE film is in a range of 0.1-20 g/m².

The contact angle of the coating is then measured and is <30°.

The light-stable layered structure of the fluoropolymer film produced in this manner without major technical effort is highly suitable for both interior and exterior use. Instead of expensive and heavy constructions made of glass, cost-effective structures can be erected or technical materials can be prepared using lightweight construction methods which, in contrast to short-lived (2-5 years) PVC or polyethylene films, have a very long service life of about 20 years.

The coating produced in accordance with the invention has a contact angle with water of <30° even after longstanding weathering, as demonstrated with the aid of accelerated weathering tests using xenon test instruments: the hydrophilic effect of the coating here can be observed even after 9000 hours.

1. A method for the production of a hydrophilic coating of a fluoropolymer material, preferably of a fluoropolymer film, wherein a coated fluoropolymer material is obtained which has a contact angle with water of less than 30°, wherein the method comprises the following steps:
providing an aqueous dispersion of silicate nanoparticles,
applying the silicate dispersion onto the fluoropolymer material, and
drying the applied coating.

2. The method according to claim 1, wherein the mean value of the particle size distribution in the dispersion is 1-100 nm, preferably 5-80 nm, particularly preferably 10-60 nm.

3. The method according to claim 1, wherein drying of the applied coating is carried out at a temperature of 40-130° C., preferably 60-120° C., particularly preferably 60-100° C.

4. The method according to claim 1, wherein drying of the applied coating is carried out for a period of 0.01-8 min, preferably 0.05-7 min, particularly preferably 0.1-5 min.

5. The method according to claim 1, wherein the silicate nanoparticles comprise, preferably consist of, tetraalkoxysilanes such as tetraethyl orthosilicate (TEOS), tetramethyl orthosilicate (TMOS), tetrapropyl orthosilicate (TPOS) and their polymers.

6. The method according to claim 1, wherein the fluoropolymer material is ethylene-tetrafluoroethylene copolymer (ETFE), polyvinylidene difluoride (PVDF) and/or a fluoropolymer (FP).

7. The method according to claim 1, wherein the surface energy of the fluoropolymer material is raised by means of priming.

8. The method according to claim 7, wherein priming is carried out on the basis of water-dilutable acrylate and/or polyurethane binders.

9. The method according to claim 1, wherein the application of the silicate dispersion to the fluoropolymer material is carried out at atmospheric pressure.

10. The method according to claim 1, wherein drying of the applied coating is carried out by means of a recirculating air dryer.

11. The method according to claim 1, wherein the application of the silicate dispersion to a fluoropolymer film is carried out by means of a gravure cylinder in a coating line, wherein the dryer length is preferably 10-50 m and the web speed is 10-100 m/min.

12. A hydrophilic fluoropolymer material which has a contact angle with water of less than 30°, in particular which can be obtained by the method according to claim 1.

13. The hydrophilic fluoropolymer material according to claim 12, wherein the hydrophilic fluoropolymer material is a coated fluoropolymer film.
